(19) United States
(12) Patent Application Publication
(10) Pub. No.: US 2014/0338598 A1
(43) Pub. Date: Nov. 20, 2014

(54) Recessed Lighting Fixture Can Stuffer

(71) Applicant: Thomas H. Tost, Fort Lauderdale, FL (US)

(72) Inventor: Thomas H. Tost, Fort Lauderdale, FL (US)

(21) Appl. No.: 14/278,977

(22) Filed: May 15, 2014

Related U.S. Application Data
(60) Provisional application No. 61/823,762, filed on May 15, 2013.

(51) Int. Cl. B05C 21/00

(52) U.S. Cl. CPC B05C 21/005
USPC 118/505

(57) ABSTRACT

A recessed lighting fixture can stuffer for covering recessed lighting fixtures has a handle attachment body, a pressing plate and a piercing pin. The handle attachment body accepts a broom handle or other extendable handle within a handle cavity. The pressing plate is affixed to the handle attachment body opposite the handle cavity, and the piercing pin is affixed adjacent to the pressing plate opposite the handle attachment body. The piercing pin can be screwed into the handle attachment body for using different shape or size piercing pins or pressing plates.

The current application claims a priority to the U.S. Provisional Patent application Ser. No. 61/823,762 filed on May 15, 2013.

### FIELD OF THE INVENTION

The present invention relates generally to home construction and remodeling. More specifically, the present invention relates to an apparatus used in remodel and new construction jobs to aid in covering recessed lighting can openings from drywall and painting materials.

### BACKGROUND OF THE INVENTION

Lighting fixtures which are recessed into walls or ceilings are an aesthetically pleasing solution to providing lighting within buildings such as offices or homes. Recessed lighting fixtures typically house a light bulb within a cylindrical can, with the opening of the can positioned flush with the wall, ceiling or other surface the lighting fixture is installed into. During a new construction or remodeling job, it is necessary to cover or block the openings of recessed lighting fixtures in order to prevent unwanted material such as drywall debris or paint from getting into the recessed lighting fixture cans. Typically, this is most easily done by stuffing crumpled newspaper into the recessed can. Other methods work as well, such as covering the opening of the can with some combination of paper and/or tape, or pressing a disposable styrofoam or paper plate, cup or bowl into the opening of the can, since they are usually a similar size to the can opening.

Some construction or remodeling jobs may involve covering many such recessed lighting fixtures, which are sometimes positioned on a ceiling far out of a worker's reach. This necessitates climbing a ladder or scaffold to be able to physically reach each recessed lighting fixture individually. This is often a dangerous and time-consuming process. A need exists for a construction worker to be able to adequately cover recessed lighting fixtures quickly and easily from a distance in order to reduce labor time, and therefore labor cost for a construction or remodeling job, as well as improving safety for the worker by eliminating the need for the worker to climb a ladder or scaffold.

It is therefore an object of the present invention to provide an apparatus with which the opening of a recessed lighting fixture can be blocked quickly, easily and from a distance.

### BRIEF DESCRIPTION OF THE DRAWINGS

FIG. 1 is a front view of the present invention.

FIG. 2 is a top view of the circular pressing plate.

FIG. 3 is a front cross sectional view of the present invention.

FIG. 4 is a front cross sectional view exploded view of the present invention.

FIG. 5 is a perspective view of the present invention with a rectangular pressing plate.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is an apparatus to aid in covering recessed lighting can openings for protection from drywall and painting materials during a construction job. In the preferred embodiment the present invention is referred to as the “Recess Can Light Stuffer.” The present invention allows a construction worker to effectively close a recessed lighting can during construction without the need to climb a ladder or build a scaffold in order for the worker to be in close proximity to the recessed lighting can, as the worker can attach an extended handle to the present invention in order to easily reach recessed lighting cans in ceilings or other hard to reach locations.

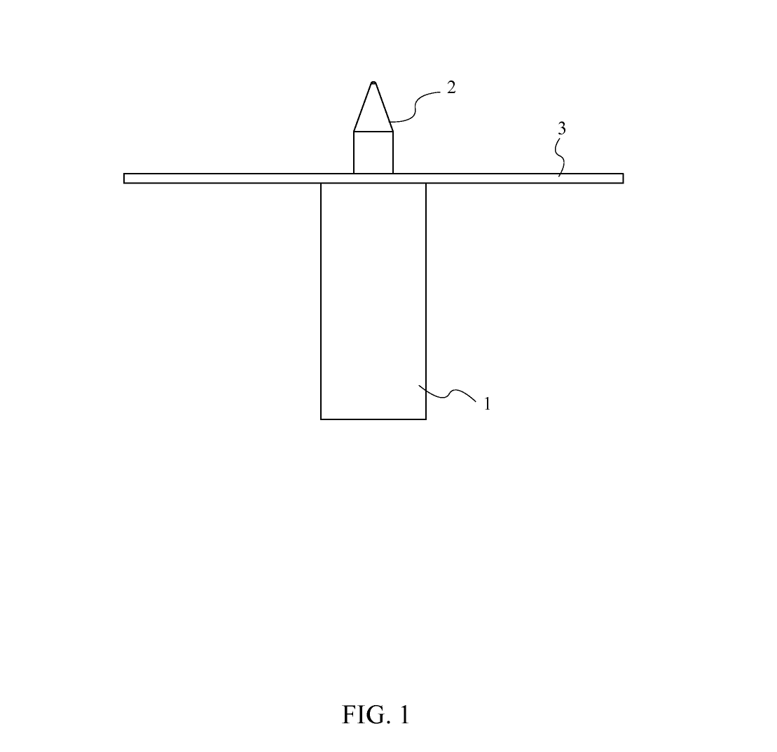

Referring to FIG. 1, the present invention generally comprises a handle attachment body 1, a piercing pin 2, and a pressing plate 3. The pressing plate 3 is positioned adjacent to the handle attachment body 1, and the piercing pin 2 is positioned adjacent to the pressing plate 3 opposite the handle attachment body 1. The piercing pin 2 is oriented perpendicular to the pressing plate 3. In one embodiment of the present invention, the pressing plate 3 is permanently connected to the handle attachment body 1 through welding, injection molding, or another means, and the piercing pin 2 is similarly connected to the pressing plate 3. In the preferred embodiment, the handle attachment body 1, the pressing plate 3 and the piercing pin 2 are all separate components which are fastened together through means described hereinafter. The preferred embodiment of the present invention may be referred to as the multi-use embodiment. The multi-use embodiment allows the user to interchangeably use different size and shape pressing plates and piercing pins. In the preferred embodiment, the piercing pin 2, the pressing plate 3 and the handle attachment body 1 are either circular or cylindrical and are oriented concentrically with each other, but it is contemplated that the spirit of the present invention may be accomplished with other embodiments such as, but not limited to, square or rectangular shaped components, or components oriented at an angle to each other.

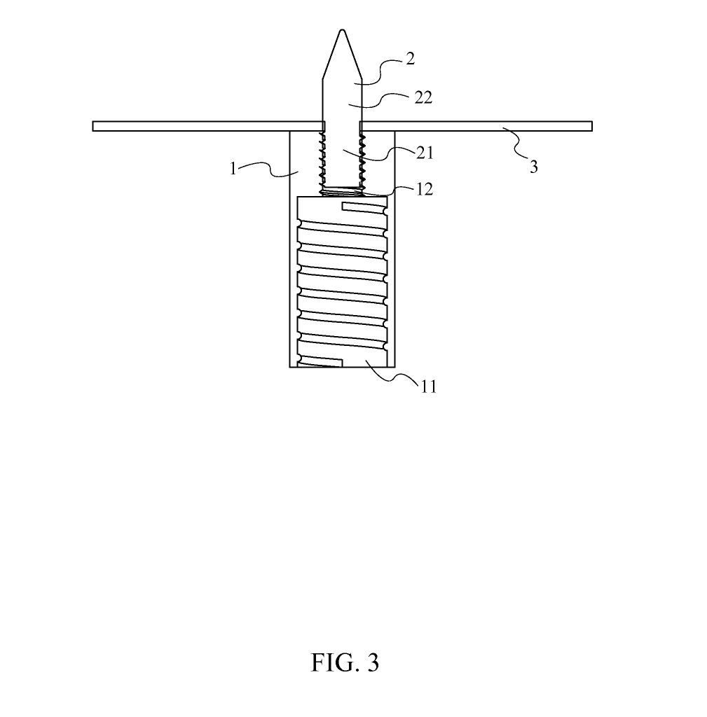

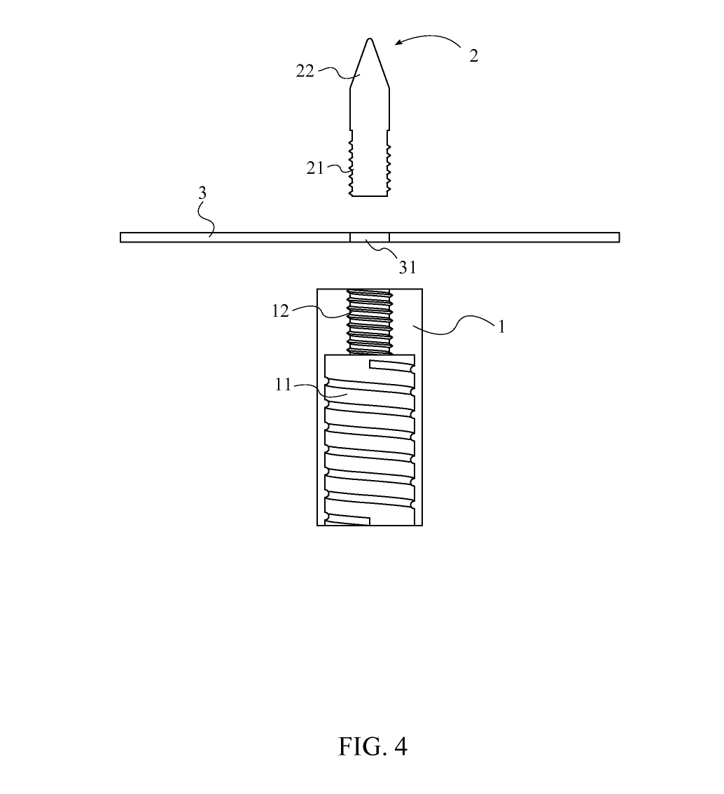

Referring to FIGS. 3-4, the handle attachment body 1 comprises a handle cavity 11, which is positioned within the handle attachment body 1, opposite the pressing plate 3 along the handle attachment body 1. The handle cavity 11 allows a handle to be inserted into the handle cavity 11 opposite the pressing plate 3. In the preferred embodiment of the present invention, the handle cavity 11 comprises internal screw threads. More specifically, in the preferred embodiment the handle cavity 11 is threaded to accommodate a typical broom threaded handle. This makes the present invention convenient for workers since a broom handle is a common and cheap apparatus able to be used with the present invention. It is contemplated that in an alternate embodiment the handle cavity 11 may not be threaded in order to accommodate un-threaded handles, though this is not preferred. In the preferred embodiment of the present invention, the handle attachment body 1 is cylindrically shaped and comprises knurling, bumps, or other features around the circumference of the handle attachment body 1 to provide grip to the user.

The piercing pin 2 is present in order to use the present invention with a piece of disposable material to cover the opening of a lighting fixture. For example, it is common to use disposable styrofoam plates or bowls to cover recessed lighting fixture openings due to the similar size of the opening and the plates or bowls. To use the present invention, the piece of disposable material is pierced with the piercing pin 2, raised to the lighting fixture, and pressed into the lighting fixture using the pressing plate 3 to apply uniform force to the piece of disposable material.

In the preferred embodiment of the present invention, the handle attachment body 1 further comprises a pin cavity 12, and the pressing plate 3 comprises a pin hole 31 which is preferably positioned centrally on the pressing plate 3. The pin cavity 12 is threaded to accept the piercing pin 2. The handle cavity 11 and the pin cavity 12 are positioned opposite each other within the handle attachment body 1, and are positioned concentrically within the handle attachment body 1. The piercing pin 2 traverses through the pin hole 31, and the piercing pin 2 is threadedly engaged within the pin cavity 12. More specifically, the piercing pin 2 comprises a threaded portion 21 and a conical portion 22, which are connected adjacent to and concentric with each other. The pin hole 31 is positioned concentrically with the handle attachment body 1 and the threaded portion 21 is traversed through the pin hole 31 and then screwed in to be threadedly engaged within the pin cavity 12. The conical portion 22 has a diameter greater than that of the pin hole 31 and in this manner, the pressing plate 3 is held in place between the handle attachment body 1 and the piercing pin 2.

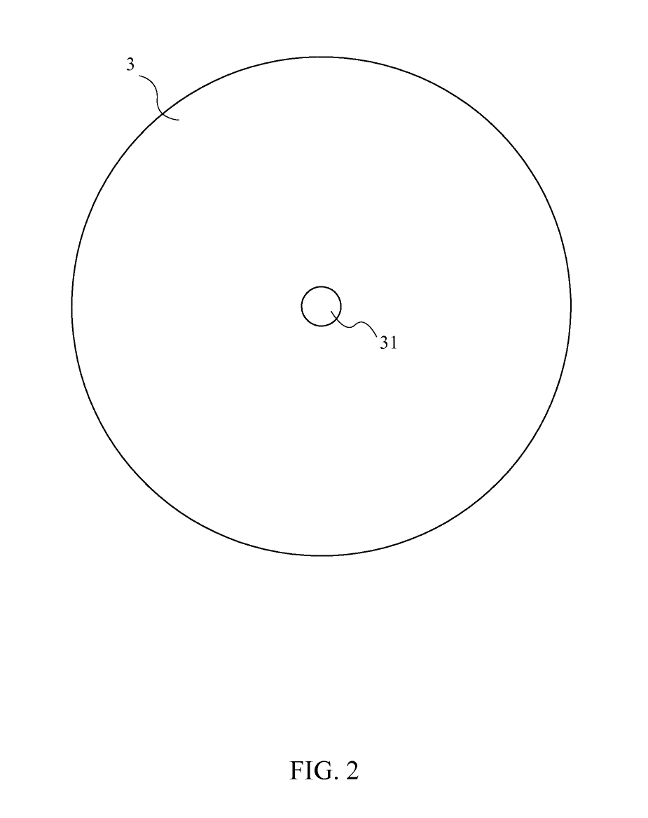

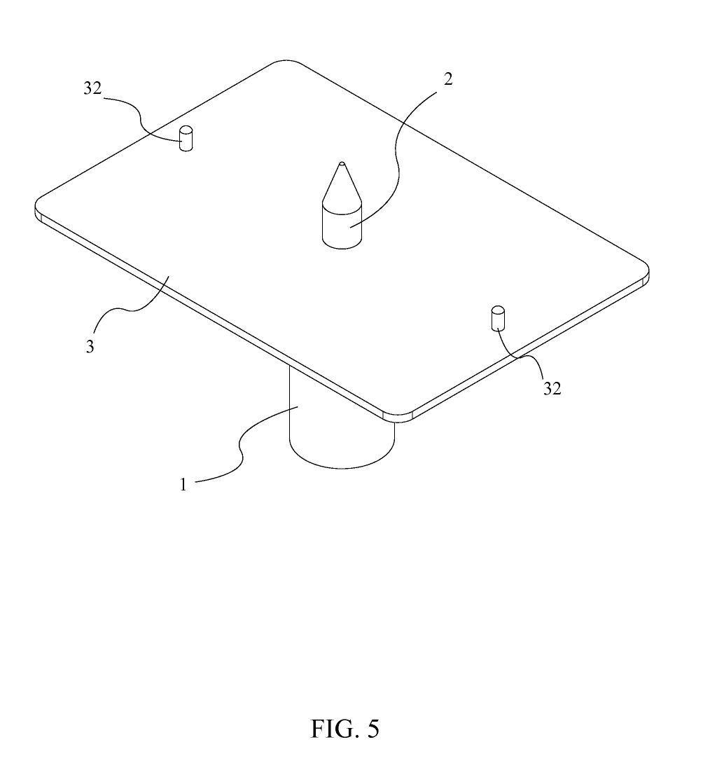

Referring to FIGS. 2 and 4, in the preferred embodiment of the present invention, the pressing plate 3 is flat and circular in shape. In alternate embodiments the pressing plate 3 may take other shapes, such as, but not limited to conical or bowl-shaped. The circular pressing plate 3 preferably comes in two embodiments, one 2 inches in diameter, and the other 4.75 inches in diameter. These two sizes represent two common sizes of recessed lighting can fixtures. In another embodiment shown in FIG. 5, the pressing plate 3 is rectangular to match the shape of air conditioner register or vent openings. In the embodiment where the pressing plate 3 is rectangular, the pressing plate 3 preferably further comprises two piercing protrusions 32 which are connected perpendicular to the pressing plate 3, and are positioned opposite each other and equidistant from the pin hole 31 on the pressing plate 3. The piercing protrusions 32 provide additional points of contact with the piece of disposable material, preventing the piece of disposable material from spinning and becoming misaligned while in use. The piercing protrusions 32 are not necessary for the circular embodiment. In the preferred embodiment of the present invention, the piercing pin 2 is ⅜ inches in diameter and 1½ inches in total height, with the threaded portion 21 being ⅝ inches in height. The pressing plate 3 is 0.09 inches in thickness. The pin hole 31 is slightly smaller than ⅜ inches and the threaded portion 21 of the piercing pin 2 should have a diameter slightly smaller than the pin hole 31. The handle attachment body 1 is 1 inch in diameter and 2¼ inches in height. The aforementioned dimensions presented are not intended in any way to limit the scope of the present invention, but to illustrate the preferred embodiment. It should be understood that alternate dimensions may be comprised.

The material of the present invention may comprise any number of materials of sufficient strength and stiffness to accomplish the purpose of the present invention. Materials the present invention may be made of comprise, but are not limited to, aircraft aluminum, dilrin plastic, injection molded plastic, another suitable metal or plastic or another suitable material not mentioned. In some embodiments the piercing pin 2 should be plastic in order to avoid grounding out sockets within recessed lighting fixtures.

Although the invention has been explained in relation to its preferred embodiment, it is to be understood that many other possible modifications and variations can be made without departing from the spirit and scope of the invention as hereinafter claimed.

What is claimed is:

1. A recessed lighting fixture can stuffer comprises:
a handle attachment body;
a piercing pin;
a pressing plate;
the handle attachment body comprises a handle cavity;
the piercing pin being positioned adjacent to the pressing plate opposite the handle attachment body;
the piercing pin being oriented perpendicular to the pressing plate;
the pressing plate being positioned adjacent to the handle attachment body;
the handle cavity being positioned within the handle attachment body, opposite the pressing plate along the handle attachment body, wherein a handle can be inserted into the handle cavity opposite the pressing plate;

2. The recessed lighting fixture can stuffer as claimed in claim 1 comprises:
the handle attachment body further comprises a pin cavity;
the pressing plate comprises a pin hole;
the handle cavity and the pin cavity being positioned opposite each other within the handle attachment body;
the piercing pin being traversed through the pin hole;
the piercing pin being threadedly engaged within the pin cavity;

3. The recessed lighting fixture can stuffer as claimed in claim 1 comprises:
the piercing pin comprises a threaded portion and a conical portion;
the threaded portion and the conical portion being connected adjacent to and concentric with each other;
the threaded portion being traversed through a pin hole of the pressing plate;
the threaded portion being threadedly engaged within a pin cavity of the handle attachment body;

4. The recessed lighting fixture can stuffer as claimed in claim 1 comprises:
the handle cavity and a pin cavity of the handle attachment body being positioned concentrically within the handle attachment body;

5. The recessed lighting fixture can stuffer as claimed in claim 1 comprises:
the handle cavity being threaded to accommodate a broom threaded handle;

6. The recessed lighting fixture can stuffer as claimed in claim 1 comprises:
the piercing pin, the pressing plate and the handle attachment body being oriented concentrically with each other;

7. The recessed lighting fixture can stuffer as claimed in claim 1 comprises:
the handle attachment body being cylindrically shaped;
a pin hole of the pressing plate being positioned concentrically with the handle attachment body;
the piercing pin being positioned concentrically with the handle attachment body;

8. The recessed lighting fixture can stuffer as claimed in claim 1 comprises:
a pin hole of the pressing plate being positioned centrally on the pressing plate;

9. The recessed lighting fixture can stuffer as claimed in claim 1 comprises:
the pressing plate being circular in shape;

10. The recessed lighting fixture can stuffer as claimed in claim 9 comprises:
the pressing plate being 2 inches in diameter;

11. The recessed lighting fixture can stuffer as claimed in claim 9 comprises:
the pressing plate being 4.75 inches in diameter;

12. The recessed lighting fixture can stuffer as claimed in claim 1 comprises:
the pressing plate being rectangular in shape;

13. The recessed lighting fixture can stuffer as claimed in claim 1 comprises:
the pressing plate comprises two piercing protrusions;
the piercing protrusions being connected perpendicular to the pressing plate;

14. The recessed lighting fixture can stuffer as claimed in claim 13 comprises:
the piercing protrusions being positioned opposite each other on the pressing plate;

15. The recessed lighting fixture can stuffer as claimed in claim 13 comprises:
the piercing protrusions being positioned equidistant from the pin hole on the pressing plate;
